(19) United States
(12) Patent Application Publication
(10) Pub. No.: US 2009/0126863 A1
(43) Pub. Date: May 21, 2009

(54) Device, installation and method for aligning and/or assembling filtering elements

(75) Inventors: Sebastien Bardon, La Ciotat (FR); Anthony Briot, Saint Saturnin Les Avignon (FR); Dominique Dubots, Salanches (FR)

Correspondence Address: OBLON, SPIVAK, MCCLELLAND MAIER & NEUSTADT, P.C., 1940 DUKE STREET, ALEXANDRIA, VA, 22314, US

(73) Assignees: SAINT-GOBAIN CTR. DE RECH. ET D'ETUDES EUROPEEN SAS, COURBEVOIE (FR); SAINT-GOBAIN INDUSTRIEKERAMIK ROEDENTAL GMBH, ROEDENTAL (DE)

(21) Appl. No.: 11/911,210

(22) PCT Filed: Mar. 6, 2006
(86) PCT No.: PCT/FR06/50195

§ 371 Date: Jun. 13, 2008

(30) Foreign Application Priority Data
Apr. 11, 2005 (DE) 20 2005 005 782.7

(51) Int. Cl. B29C 65/48

(52) U.S. Cl. 156/197; 156/381

(57) ABSTRACT

A device for aligning and/or assembling filtering elements, in particular of particulate filter, an installation for assembling a filter from filtering elements incorporating the device, and a method for aligning and/or assembling monolithic filtering elements, in particular for making a particulate filter. The device includes a back plate whereon are set the filtering elements, the back plate being for example fixed on a base plate, and walls laterally foldable upwards by a folding mechanism, such that the filtering elements are mutually maintained tightly when the walls are in an upper position.

The invention relates to a method, a device or an installation for assembling and/or manufacturing particulate filters comprising several monolithic elements, particularly suited to application in the exhaust system of a diesel engine.

The particulate filters used in the exhaust systems of internal combustion engines, more especially in motor vehicles of the diesel type, usually have a honeycomb structure. Such structures comprise a collection of adjacent ducts or passages of mutually parallel axes separated by porous filtering walls, which ducts are closed at each end to delimit inlet chambers opening onto the inlet face and outlet chambers opening onto the discharge face. The materials used are particularly of a ceramic nature, for example cordierite, silicon carbide, etc.

In order to solve the problems of thermomechanical integrity associated with the regeneration phases inherent in the operation of a particulate filter in an exhaust system and thus improve its life, filtering structures that combine several monolithic honeycomb blocks or elements have been proposed. The elements are usually assembled together by bonding using an adhesive or a cement of a ceramic nature, forming a joint between the elements, and referred to as a bonding or jointing cement in the remainder of the description.

Examples of the manufacture of such filtering structures are described for example in Patent EP 1 479 882 A1. According to the teaching of that document, the parallelepipedal elements, also referred to as monolithic blocks, are bonded, one after the other, in a horizontal position in the direction of their length, on a V-shaped guide formed of two flat supports, usually perpendicular to one another. The assembled elements are then dried and machined to form the finished structure, the peripheral part of which is usually surrounded by a coating cement in order to ensure that it is correctly gastight in use. This method of assembly is, however, painstaking because the elements are handled one after the other. This makes the method expensive and not very productive. Furthermore, the time that the bonding cement deposited on the first element spends drying or even curing has always to be longer than that related to the last element assembled, and this may generate uncontrolled non-uniformity of structure which is detrimental to the life of the filter or even simply to handling it.

It is an object of the present invention to provide a method for aligning and/or assembling such monolithic elements but in particular allows large numbers of such filters to be manufactured with good productivity and for a lower cost. It is another object of the invention to obtain assembled filters within which the bonding cement is distributed in a controlled and uniform manner between the elements.

More specifically, the present invention in a first aspect relates to a device for aligning and/or assembling filtering elements, particularly of a particulate filter, said device comprising a bottom plate on which said elements are placed, said bottom plate being, for example, fixed to a base plate, and walls that can be folded laterally upward by folding means in such a way that said elements are held tightly together when said walls are in the folded-up position.

For example, the walls are articulated to the base plate by means of hinges positioned around the periphery of the base plate.

According to one possible embodiment, said lateral walls are arranged in such a way that they can be folded using a closure frame that can move in the heightwise direction.

Each wall may be equipped with at least one closure cam which interacts with a bearing, positioned opposite it on the closure frame.

According to an advantageous embodiment, the walls may be locked in position with retaining bolts on the closure frame, using engaging elements which are positioned on at least two opposite walls, in which the base plate is arranged by fixing it to a pallet and in which the closure frame can be actuated using lifting elements of an electronically controlled lifting device.

For example, the bearing is a roller bearing.

Typically, the lifting elements of the lifting device may be hydraulic or pneumatic actuators or linear units consisting of a rotor and of a casing of a linear motor.

According to an advantageous embodiment, an adapter plate is positioned on each of the interior faces of the walls, said adapter plates preferably being made of a flexible or plastic material or connected to the removable walls by a system of springs or flexible material.

The invention further relates to an installation for assembling a filter from filtering elements, comprising a device as described hereinabove and means for injecting or depositing an adhesive or a cement between the elements present within said device.

Said installation may further comprise means for parting said elements and rocking them onto the walls.

According to an advantageous embodiment, the wall-folding means are coordinated with or slaved to the injection or depositing means.

Finally, the invention relates to a method of aligning and/or assembling monolithic filtering elements, particularly with a view to manufacturing a particulate filter, said method comprising the following steps:
a step of positioning said elements in a device as claimed in one of the preceding claims,
a step of aligning said elements, under the action and movement of walls that can be folded laterally by the folding means, in such a way that said elements are held tightly together when said walls are in the folded-up position.

According to a first embodiment, those external walls of the elements that have been brought into contact with one another by the movement of the folding walls are precoated with an adhesive or with a cement.

According to a preferred second embodiment of the method, after the positioning step, a step of injecting or depositing a jointing cement or adhesive between said elements.

In a typical method of assembly according to the invention, the following steps are performed in turn:
the various elements are positioned on the support according to their respective positions in the finished assembly,
the elements are fixed in a position and with a spacing that will allow the cement or the adhesive to be injected,
the jointing cement or adhesive is injected between the lateral faces of the walls of the elements that have been positioned facing each other and the elements are moved closer together in a slaved fashion under the action of the folding walls,
said folding walls are kept in the folded-up position so as to keep the elements pressed together until the adhesive or the cement has cured or set,
the assembled filter is demolded by reducing the pressure exerted by removing the folding walls.

The method may further comprise a step of heat treating the filter prior to the demolding step.

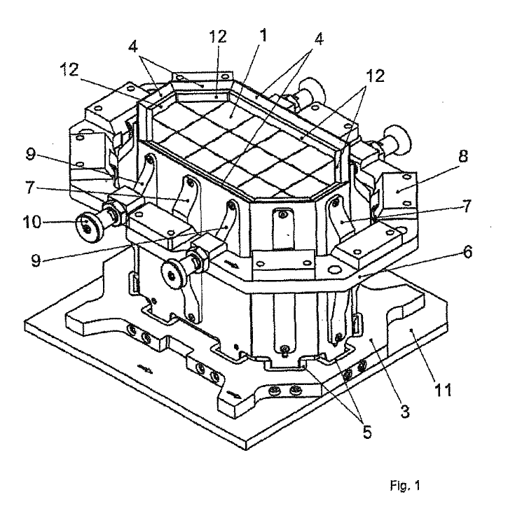

The invention will be better understood from reading a nonlimiting exemplary embodiment of a device and of an installation according to the invention, and of the method for implementing these, this embodiment being illustrated by FIGS. 1 to 3 in which:

FIG. 1 gives a three-dimensional depiction of the device according to the invention, in the closed position when it contains the filtering elements,

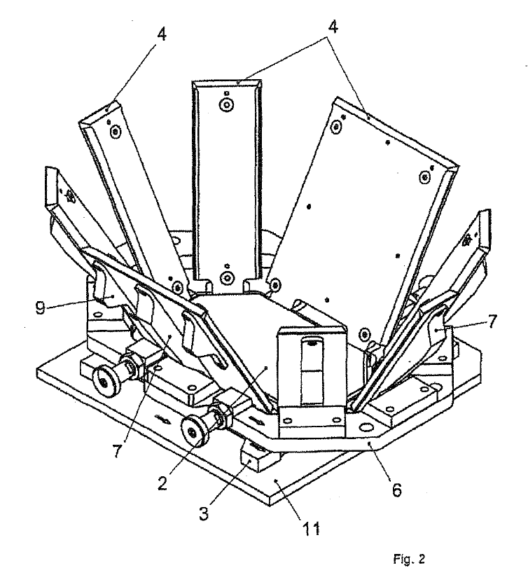

FIG. 2 is a three-dimensional depiction of the device in the open position, before said elements are inserted,

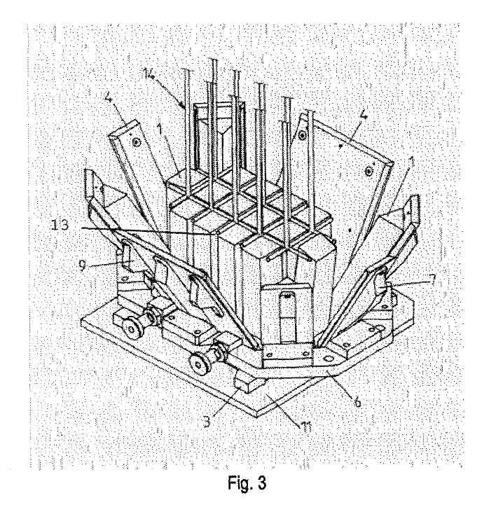

FIG. 3 illustrates a particular embodiment of the device and the implementation of such a device within an installation for assembling a filter, in which installation a jointing cement is also injected between the elements.

FIG. 1 depicts a device for aligning and/or assembling filter elements 1 of a particulate filter, particularly a diesel particulate filter. The filtering elements 1 are placed on a bottom plate 2 in the form of a packet. The bottom plate 2 is fixed to a base plate 3. Walls 4 that can be folded upward are articulated to the base plate 3 using hinges 5, the walls 4 being foldable using a closure frame 6 that can move up and down. When moved up, the walls 4 surround the filtering elements 1 collected together in the form of a packet and hold them firmly together. Although, in the way it has been depicted in FIG. 1, a slot is formed between the filtering elements 1 and the walls 4, an adapter plate 12 which closes said slot and, when the walls 4 are folded up, most definitely holds the filtering elements 1 against one another, is fixed respectively to the interior faces of the walls 4. In order to achieve a uniform and guided movement as the walls 4 are closed and opened, these walls are equipped with at least one closure cam 7. These closure cams 7 interact with a bearing 8, for example a roller bearing, on the closure frame 6. In order to be able to immobilize the closure frame 6 in its raised position in which it holds the packet of filtering elements 1 which is placed on the bottom plate 2, the closure frame 6 has retaining bolts 10 which engage in corresponding engagement elements 9 on the walls 4. The base plate 3 which bears the bottom plate 2 is fixed to a pallet 11. The pallet 11 may be the transport pallet of a transport system that allows the filtering elements 1 to be carried away to a drying process in which the particulate filter is created in the form of a fixed packet consisting of the filtering elements 1. The closure frame 6 is actuated by means of an electronically controlled lifting device which has not been depicted in the drawing. For this, the lifting elements of the lifting device are connected adaptively to the closure frame 6. The lifting elements of the lifting device may be hydraulic actuators or pneumatic actuators. Furthermore, they may be designed in the form of a linear unit, consisting of a rotor and of a casing of a linear rotor.

FIG. 2 depicts the device open, without the adaptor plates 12. The closure frame 6 is moved into the lowered position by the lifting element of the lifting device, the laterally folded walls 4 are resting on the closure frame 6 with the closure cams 7 against the bearings 8. In this position, the bottom plate 2 is fitted with the filtering elements 1 in a loose packet or the particulate filter formed from the packet through a drying process is removed. This device has the particular advantage that the efforts involved in closure and the rates of closure of the closure frame 6 can be controlled through the electronically controlled lifting device.

A method of assembling a filter from monolithic elements and a device according to the invention will now be described in conjunction with FIG. 3. The installation comprises the aforementioned device combined, for example, with parting means (not depicted in FIG. 3) and means (14) for injecting a cement between the monolithic elements 1 that are to be assembled.

The method of implementing the installation comprises the following steps:

First, the elements are placed in the device held in the open position (cf. FIG. 2). The elements are placed, still approximately, according to their respective positions in the finished assembly. The device is first closed, by moving the closure frame 6 and the walls 4 into their raised position (cf. FIG. 1), in order to obtain optimum positioning of the elements relative to one another. The device is then partially opened, the walls 4 typically making an angle of between 20 and 50° with respect to the vertical. A metal frame 14 comprising hollow vertical and horizontal tubes for the passage of the jointing cement is positioned over the elements, as illustrated in FIG. 3. The frame is tailored to the configuration and layout of the elements in the device. The horizontal hollow tubes are equipped in their lower part with nozzles for injecting the jointing cement. The elements are parted by rocking them towards the walls (4), for example using a pneumatic handling system of a known type (not depicted in FIG. 3) comprising, for example, gripper fingers of cylindrical shape, preferably with an end-piece for example based on silicone rubber or any other equivalent means to reduce the abrasion of the fingers and prevent damage to the elements. The distance 13 thus obtained between the upper edges of the elements 1 then allows the frame 14 to be lowered down between the elements, as illustrated in FIG. 3. For greater clarity, the separation between the lateral walls 4 has been exaggerated in FIG. 3. When the frame is in its lowest position, the jointing cement is progressively injected through the nozzles to fill the space between the elements from the bottom up. Advantageously, the injection of the cement is coordinated with a progressive rising movement of the frame 14 and closure of the sides 4. In particular, closure of the assembly device is regulated and slaved to the position of the injection frame. An arrangement such as this ultimately makes it possible to obtain an assembled filter with a thickness of joint that is uniform and homogeneous throughout the volume of the filter. Furthermore, the use of the current device in a method for assembling a filter as previously described also has the advantage of limiting the frequency with which the equipment needs to be cleaned, as cement overspill flash is concentrated mainly between and on the top faces of the elements.

According to the invention, if flash is formed as the box is closed as a result of increased flowability of the cement, this flash advantageously remains concentrated on the support plate or pallet 11. Furthermore, the system of foldable lateral walls positioned on the pallet 11, dissociated from the installation for injecting or depositing cement, the handling for separating or rocking the elements, and from the system for folding the walls, makes the machine quicker and easier to clean.

The invention as has just been described can obviously be varied and/or improved in numerous ways that will be obvious to those skilled in the art. Such variations must of course be understood as being included within the scope of the present invention. More particularly, such variations may consist in one or more of the following arrangements:
the handling system, the mechanical elements of the device or of the installation, particularly those used to part the elements, particularly the moving walls, or move them closer together, are suited to elements made of ceramic when these are abrasive such as SiC for example. For example, the adapter plates 12 visible in FIG. 1 (but not carried over onto FIGS. 2 and 3 for better clarity) are surface-treated or based on a material of the Teflon or silicone or treated steel type. The adapter plates 12 may possibly be chosen to be flexible or plastic in order to cushion the fall of the ceramic elements and prevent them from breaking. According to another embodiment, the plates 12 are connected to the removable walls 4 by a system of springs or flexible material in order further to improve the flexibility of the method, particularly against possible dimensional fluctuations of the elements within one manufacturing batch or from one batch to another.
The dimensional tolerances on the elements are tailored to the required quality of the joint: cross-sectional dimensions, perpendicularity of the support face with respect to a lateral face or of lateral faces with respect to one another, concavity or convexity of the lateral faces.
The mechanical integrity of the element prior to assembly is chosen and tailored, on the one hand, to suit the pressure exerted by the closure device and, on the other hand, the opposing pressure exerted by the jointing cement. A choice such as this may, in particular, be dependent on the wall thickness of the element, its geometry and its porosity.
The particle size and the rheology of the jointing cement used for assembly are adapted using the rules of the art to suit the chosen method and the required dimensional characteristics of the joint. In particular, the cement or adhesive has a suitable plasticity that allows it to be compressed during shaping. If the cement or adhesive is applied by injection as illustrated in FIG. 3, then the cement needs to have rheological properties that will allow it to be injected without excessive difficulty, it needs to have a suitable drying and/or curing time to prevent it from setting too quickly while blocking the injection nozzles, for example, and preferably needs to have a rheofluid behavior so that it does not block the injection nozzles.
The device according to the invention, in its closed position, has an interior shape and an interior volume that are similar to the shape and to the volume of the assembled filter ultimately obtained, accounting for the size of the joints between the elements.
A device according to a preferred embodiment of the invention for example consists of an outer frame which rises and the rate of which can be regulated, in combination with closure cams, so as to obtain a uniform and guided movement of the walls. The closure frame for example has adjustable retaining bolts so that the pressure exerted on the elements can be controlled in order not to break them.
The device is closed to a level that does not correspond to the maximum height of the closure frame but to a fraction thereof, typically around 90%, so that the elements can still slide relative to one another and reposition themselves at the same height on the bottom plate. The heightwise repositioning of the elements thus makes it possible to obtain improved flatness of the assembled filter.
A plate, of appropriate weight and shape, is placed and presses on all the elements once the injection frame has been removed. This alternative form further improves the control over the flatness of the inlet and outlet faces of the filter.
The adhesive or the cement may be set or cured prior to the demolding of the assembled filter either cold, by adding one or more accelerants to the cement or by applying infrared or UV or microwave radiation, or using any other known means for applying heat.
According to one possible embodiment of the invention that further minimizes the risks of certain passages becoming blocked as a result of possible overspill of jointing cement, it is possible, according to the invention, to affix masks prior to the assembly operation.
According to the invention, the passages that open onto each end of the elements are, as an alternative, pre-plugged prior to assembly, after the fashion described for example in applications EP 1 508416 or EP 1516658 but, as an option, they may just as well not be plugged.
The elements may comprise, but do not have to comprise, a spacer for controlling the thickness of the joint.
The elements may have been prepared in such a way as to exhibit regions of different adhesion, as described for example in applications FR 2853256 or EP 1591431.
The elements may adopt any possible shape for assembly. They may, for example, have a square or rectangular, triangular, hexagonal, etc. shape, or may be a mixture of these shapes.
According to one alternative form of the invention, a self-flow cement is used as a jointing cement. In such a case, the necessary amount of cement is not injected but is simply deposited by appropriate means merely under gravity, that is to say solely under the effect of its own weight, between the elements. A self-flow cement must be understood within the meaning of this description to mean refractory mortars known in English as “self-flow” compounds in accordance with the terminology defined by the standard ASTM C71 “standard terminology relating to refractories”. Typically, these are wet mixes which can be used without vibration or external energy supply, without causing segregation.

### LIST OF REFERENCES

1 Filtering elements
2 Bottom plate
3 Base plate
4 Walls
5 Hinges
6 Closure frame
7 Closure cams
8 Bearing
9 Engagement elements
10 Retaining bolt
11 Pallet
12 Adapter plate
13 Distance between the upper edges of the elements
14 Injection frame

1-16. (canceled)

17. A device for aligning and/or assembling filtering elements, comprising:
a bottom plate on which the filtering elements are placed, the bottom plate configured to be fixed to a base plate; and
walls that can be folded laterally upward by folding means such that the filtering elements are held tightly together when the walls are in a folded-up position.

18. The device as claimed in claim 17, in which the walls are articulated to the base plate by hinges positioned around the periphery of the base plate.

19. The device as claimed in claim 17, in which the lateral walls are configured to be folded using a closure frame that can move in the heightwise direction.

20. The device as claimed in claim 19, in which each wall includes at least one closure cam that interacts with a bearing, positioned opposite it on the closure frame.

21. The device as claimed in claim 20, in which the walls are locked in position with retaining bolts on the closure frame, using engaging elements positioned on at least two opposite walls, in which the base plate is arranged by being fixed to a pallet, and in which the closure frame is configured to be actuated using lifting elements of an electronically controlled lifting device.

22. The device as claimed in claim 20, in which the bearing is a roller bearing.

23. The device as claimed in claim 21, in which the lifting elements of the lifting device are hydraulic or pneumatic actuators or linear units of a rotor and of a casing of a linear motor.

24. The device as claimed in claim 17, in which an adapter plate is positioned on each of interior faces of the walls, the adapter plates being made of a flexible or plastic material or connected to the removable walls by a system of springs or flexible material.

25. An installation for assembling a filter from filtering elements, comprising:
a device as claimed in claim 17; and
means for injecting or depositing an adhesive or a cement between the filtering elements present within the device.

26. The installation as claimed in claim 25, further comprising means for parting the filtering elements and rocking the filtering element onto the walls.

27. The installation as claimed in claim 25, in which the wall-folding means are coordinated with or slaved to the injection or depositing means.

28. A method of aligning and/or assembling monolithic filtering elements, comprising:
positioning the filtering elements in a device as claimed in claim 17; and
aligning the filtering elements, under action and movement of walls that can be folded laterally by the folding means, such that the filtering elements are held tightly together when the walls are in the folded-up position.

29. The assembly method as claimed in claim 28, in which external walls of the filtering elements that have been brought into contact with one another by movement of the folding walls are precoated with an adhesive or with a cement.

30. The assembly method as claimed in claim 28, further comprising, after the positioning, injecting or depositing a jointing cement or adhesive between the filtering elements.

31. The assembly method as claimed in claim 30, further comprising:
positioning the filtering elements on a support according to their respective positions in a finished assembly;
fixing the filtering elements in a position and with a spacing that will allow the jointing cement or the adhesive to be injected;
injecting the jointing cement or adhesive between lateral faces of the walls of the filtering elements that have been positioned facing each other, and moving the filtering elements closer together in a slaved fashion under action of the folding walls;
keeping the folding walls in the folded-up position so as to keep the filtering elements pressed together until the adhesive or the jointing cement has cured or set; and
demolding an assembled filter by reducing pressure exerted by removing the folding walls.

32. The assembly method as claimed in claim 31, further comprising heat treating prior to the demolding.
